(19) United States
(12) Patent Application Publication
(10) Pub. No.: US 2026/0323155 A1
(43) Pub. Date: Oct. 15, 2026

(54) METHOD AND DEVICE FOR DOCUMENTING CONTACT PATTERNS

(71) Applicant: Klingelnberg AG, Zurich (CH)

(72) Inventors: Christian Pahud, Uitikon (CH); Martin von Ehrenberg, Freienwil (CH); Stefan Herzhoff, Hückeswagen (DE)

(21) Appl. No.: 19/571,817

(22) Filed: Mar. 19, 2026

(30) Foreign Application Priority Data
Mar. 19, 2025 (EP) 25164759.0

(51) Int. Cl. H04N 23/63; G01M 13/021; H04N 23/60

(52) U.S. Cl. CPC H04N 23/635; G01M 13/021; H04N 23/632; H04N 23/64

(57) ABSTRACT

A method for documenting contact patterns includes the steps of providing a gear with a contact pattern and photographically documenting the contact pattern, wherein a reference graphic superimposed on the live image in a display of a camera is used for handheld, repeatable alignment of the camera to produce an image.

### CROSS-REFERENCE TO RELATED APPLICATIONS

This application claims the benefit of European patent application no. 25164759.0, filed on 19 Mar. 2025, the disclosure of which is incorporated herein by reference in its entirety.

### TECHNICAL FIELD

The present disclosure relates to a method and device for documenting contact patterns.

### BACKGROUND

In industrial practice, gear pairings are checked with regard to their contact pattern. For this purpose, contact pattern paint or marking paste is applied to the tooth flanks, for example, which makes the contact pattern visible after rolling.

The documents DE 10 2015 204 554 B4, DE 10 2016 206 812 A1, DE 198 40 969 C2, U.S. Pat. No. 5,610,994, and WO 2021/242549 each describe complex and cost-intensive test benches and methods for the partial or fully automatic documentation of contact patterns of gear pairs in tooth engagement. In particular, test benches with expensive camera systems are used, which enable the contact pattern of the gear pairs to be documented directly in the state in which they are mounted on the test bench.

Despite the cost-intensive test bench technology, such systems usually require long set-up times if the test bench is to be set up for a new gear geometry or if a change to a different gear geometry is made in the test setup. This is because the alignment and adjustment of the camera systems for contact pattern recording requires operator intervention, especially for bevel gears with their often strongly curved flanks.

In many cases, such complex solutions for contact pattern documentation are not necessary or economical in operational practice. In some cases, manual contact pattern documentation is carried out in operational practice using adhesive strips, with the aid of which a contact pattern in the form of marking paste is removed from a tooth flank. These adhesive strips are stuck onto a report in order to document the contact pattern.

It is also known to take photographs of contact patterns with a handheld camera, wherein the result of this documentation depends heavily on the operator's behavior. The photographs differ depending on the operator in terms of shooting distance, shooting angle, and exposure. This makes it difficult to compare and evaluate contact patterns documented in this way.

### SUMMARY

Against this background, the present disclosure is based on the technical problem of providing an improved method and an improved device for carrying image documentation, which in particular enable cost-effective, flexible, and reproducible contact pattern documentation.

The technical problem described above is solved in each case by the features of the independent claims. Further designs of the disclosure are apparent from the dependent claims and the following description.

According to the disclosure, a method is specified having the following method steps: providing a gear, wherein a substance for visualizing a contact pattern, such as contact pattern paint, marking paste or the like, is present on the tooth flanks of the gear, and wherein the substance has been partially removed and/or displaced as a result of the gear rolling against a counter gear, so that the contact pattern is visualized; photographically documenting the contact pattern of one or more tooth flanks by aligning a handheld electronic device, such as a smartphone, tablet, or the like, which has a camera and a display as an electronic viewfinder for the camera, relative to the contact pattern to be documented, wherein, during alignment and before triggering the camera, a reference image of at least a section of the gear is superimposed on a live viewfinder image of the camera displayed on the display in order to enable repeatable, handheld alignment of the camera relative to the gear, and triggering the camera to produce a photographic image of the contact pattern.

The present method enables repeatable, manual contact pattern capture using the handheld electronic device, in which the reference image superimposed on the live viewfinder image simplifies manual alignment and positioning of the handheld electronic device relative to the gear.

The respective user therefore only needs to align the handheld electronic device in such a way that the live viewfinder image is as congruent as possible with the reference image superimposed on the live viewfinder image. This allows intuitive positioning and orientation of the handheld electronic device relative to the gear without the respective operator having to have any special knowledge of the documentation and evaluation of contact patterns.

The operator's influence on the documentation and evaluation of contact patterns can thus be reduced, as contact patterns are always captured in the same, reproducible manner by different operators, i.e., with the same camera orientation and a comparable image section.

Another advantage is that handheld electronic devices such as smartphones, tablets, or similar devices, which are inexpensive and available in large quantities, can be used for the photographic documentation of the respective contact pattern. In everyday business practice, a large number of people have access to smartphones or tablets, for example, so that, in comparison to previously known solutions, no expensive camera systems need to be purchased for contact pattern documentation. In addition, most people are already familiar with the operation and operating system of such handheld electronic devices, such as smartphones or tablets, from their private and work environments, so that no training is required to use these devices. Due to the low weight and wide availability of handheld electronic devices, the present method can also be used quickly and flexibly, without requiring a great deal of setup or adjustment for documentation.

The disclosure thus provides an improved method that is cost-effective and flexible to use and also enables reproducible contact pattern documentation.

The reference image may, for example, be a partially transparent reproduction of a photograph of an identical gear. Accordingly, the reference image may be an image file that is displayed on the screen and superimposed on the live viewfinder image as a partially transparent image in order to simplify the alignment of the handheld electronic device relative to the gear.

The degree of transparency of the reference image may be adjustable. For example, a transparency of 50% may be set as the initial value, and the degree of transparency may be increased or reduced based on this initial value. This is because, depending on the prevailing lighting conditions, i.e., in particular the incidence of light on the display, it may be necessary to make the reference image more or less transparent in order to be able to recognize and distinguish both the reference image and the live viewfinder image on the display.

The reference image may have at least one reference graphic derived from a photographic image of an identical gear, such as a contour, a line model, corner points, or the like. The line thickness and/or color of the reference graphic may be adjustable.

The reference image may include at least one reference graphic derived from target data of the gear, such as a contour, a line model, corner points, or the like. The line thickness and/or color of the reference graphic may be adjustable.

If the reference image has a reference graphic derived from a photographic image of an identical gear, it may be provided that this reference graphic has been manually reworked and/or verified and/or improved on the basis of target data of the gear. This can serve to correct artifacts or faulty areas of the reference image. This is because the metallic, reflective surfaces of a gear, which often do not contrast strongly with adjacent structures or the background, pose a particular challenge for software-based applications for edge detection in image files.

The reference image may be a combination of the aforementioned variants, so that, for example, a partially transparent image of a photograph of an identical gear together with a simultaneously displayed reference graphic serves as the reference image.

According to one design of the method, the photographic documentation may be carried out using a software program product that accesses the camera and the display, wherein the software program product is executed on the handheld electronic device or is accessed web-based in a browser of the handheld electronic device.

The software program product may be configured to access a database in which one or more of the following data is stored: Reference images for different gear geometries; data for gear-specific designation of a photographic image and/or a reference image, such as a serial number, gear designation, gearing data, or the like; one or more document templates for generating reports from the photographs of contact patterns and gear-specific reports generated from the document template or templates.

The software program product can therefore support an operator of the handheld electronic device by means of the database, in which reference images, data for gear-specific naming, and document templates for generating reports can be accessed directly in the software program product. For example, reports can be created by adding a serial number or gear designation to photographic images of contact patterns. Such serial numbers or gear designations may be available, for example, in a selection list of the software program product.

Alternatively or in addition, it may be provided that, as part of the photographic documentation, a gear-specific, machine-readable code, such as a QR code, a barcode, or the like, is scanned to identify the gearing, wherein the software program product has a code scanner, and wherein scanning the gear-specific, machine-readable code retrieves gear-specific data from the database, in particular that the gear-specific, machine-readable code is displayed on a monitor of a gear cutting machine or a test bench.

The code scanner can access the camera of the handheld electronic device. This allows the gear-specific, machine-readable code to be easily captured using the electronic device.

Various data stored in the database can be assigned to the gear-specific, machine-readable code. Scanning the gear-specific, machine-readable code can trigger the retrieval of a gear-specific reference image, wherein gear-specific data is automatically assigned to a photographic image of a contact pattern created subsequently and the photographic image is added to a report. As a result of the database link, the operator does not have to make error-prone manual entries, but can trigger correct photographic documentation and logging simply by scanning the gear-specific, machine-readable code.

In other words, it may be provided that, as a result of scanning the gear-specific, machine-readable code, a gear-specific reference image is retrieved from the database and/or gear-specific data is added to a gear-specific report containing at least one photographic image of a contact pattern.

It may be provided that gear-specific data is added as metadata to an image file of the respective photographic images of contact patterns, so that the respective image file itself can be uniquely identified on the basis of the metadata, even without the existence of a report.

A respective report can be stored in the database as a PDF file or similar, for example.

It may be provided that target data for the geometry are assigned to the gear-specific, machine-readable code, wherein a reference image is generated on the basis of this target data as a result of scanning the gear-specific, machine-readable code.

According to one design of the method, it may be provided that during alignment and before triggering the camera, predefined parameters of the camera, such as exposure parameters and/or zoom settings or the like, are called up, in particular that these predefined parameters are linked to the reference image so that when the reference image is called up, the predefined parameters for the camera are also loaded.

It may be provided that, before photographically documenting a gear for which no reference image is yet available, one or more reference images are generated.

According to one design of the method, it may be provided that the camera is triggered automatically if the reference image overlaps with the gear to be documented with a predetermined degree of accuracy.

The disclosure specifies a device designed for the photographic documentation of a contact pattern of one or more tooth flanks of a gear, wherein the device is a handheld electronic device, such as a smartphone, a tablet, or the like, wherein the handheld electronic device has a camera and a display as an electronic viewfinder for the camera, wherein the device is designed to superimpose a reference image of at least a section of the gear to be documented on a live viewfinder image of the camera displayed on the display during alignment and before the camera is triggered, in order to enable repeatable, handheld alignment of the camera relative to the gear to be documented.

The device may be designed to perform the photographic documentation using a software program product that accesses the camera and the display, wherein the software program product is executed on the electronic device or is accessed web-based in a browser of the electronic device.

The software program product may be designed to access a database in which one or more of the following data is stored: Reference images for different gear geometries; data for naming a photographic image and/or a reference image, such as a serial number, gear designation, gearing data, or the like; one or more document templates for generating reports from the photographic images of contact patterns and gear-specific reports generated from the document template or templates.

### BRIEF DESCRIPTION OF THE DRAWINGS

The disclosure is explained in more detail below with reference to a drawing illustrating an exemplary embodiment. The following figures show schematically:

FIG. 1A shows a smartphone in a front view;

FIG. 1B shows the smartphone from FIG. 1A in a rear view;

FIG. 2 shows a bevel gear pair in an axial section;

FIG. 3 shows a ring gear in a perspective view;

FIG. 4 shows the creation of a reference image of the contact pattern of a bevel gear;

FIG. 5 shows the creation of a reference image from the reference recording according to FIG. 5;

FIG. 6 shows the reference image in the form of a reference graphic;

FIG. 7 shows the smartphone from FIG. 1A with the reference graphic before alignment and positioning;

FIG. 8 shows the smartphone from FIG. 1A in the aligned and positioned state;

FIG. 9 shows a report of a documentation of contact patterns; and

FIG. 10 shows a method step of a method according to the disclosure.

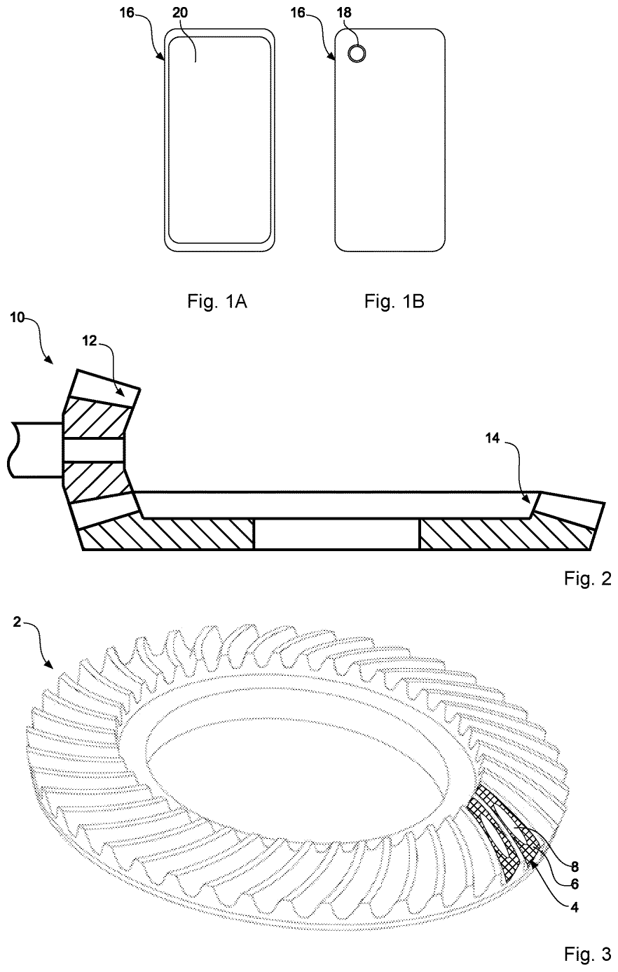

### DETAILED DESCRIPTION OF THE DRAWINGS

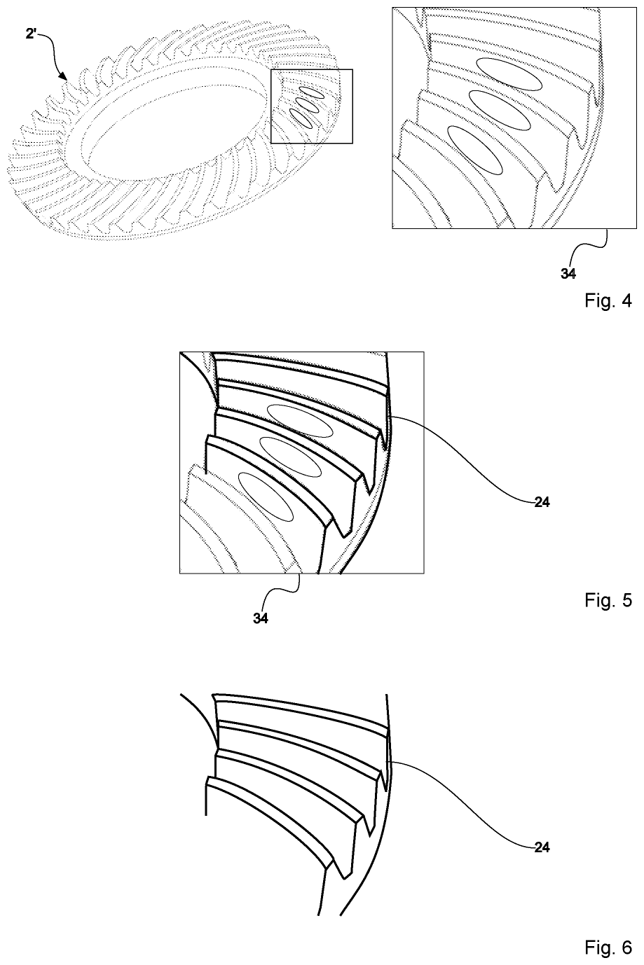

According to the disclosure, a gear 2, such as the bevel gear shown in FIG. 3, is first provided.

A substance 6 for visualizing a contact pattern 8 is present on the tooth flanks 4 of the gear 2—in this case, marking paste. It is understood that all tooth flanks 4 of the gear 2 are coated with marking paste 6, although for the sake of simplicity, only two tooth flanks 4 with marking paste 6 and a visible contact pattern 8 are shown.

The marking paste 6 has been partially removed and/or displaced in a known manner as a result of the gear 2 rolling against a counter gear, so that the contact pattern 8 is visualized. FIG. 2 shows, by way of example and schematically, a bevel gear pair 10 in axial section, with a pinion 12 and a ring gear 14, wherein the pinion 12 can be, for example, such a counter gear 12 for the ring gear 2 from FIG. 3.

The principle of visualizing a contact pattern 8 using marking paste 6 is described in the prior art mentioned in the introduction and is generally well known.

In a next step, the contact pattern 8 of one or more tooth flanks 4 is documented photographically.

For this purpose, a handheld electronic device 16 (FIG. 7, FIG. 8) is aligned by an operator relative to the contact pattern 8 to be documented, The marking paste still present on the gear 2 is shown only in FIG. 3 for the sake of clarity. It should be noted that all drawings showing a contact pattern 8 relate to tooth flanks coated with marking paste.

The handheld electronic device 16 is a smartphone in this case. The smartphone 16 has a camera 18 and a display 20 as an electronic viewfinder for the camera 18. This means that when the camera 18 is activated, the display 20 shows a live viewfinder image of the image currently captured by the camera 18.

While aligning the camera 18 or smartphone 16 relative to the contact pattern 8 to be documented and before triggering the camera 18, a reference image 24 of at least a section of the gear 2 is superimposed on a live viewfinder image 22 of the camera 18 displayed on the display 20 in order to enable the operator to repeatedly and accurately manual alignment of the camera 18 relative to the gear 2.

The reference image 24 is shown here with a greater line thickness than the live viewfinder image 22 of the camera 18. The reference image 24 is a reference graphic in the form of contours derived from a reference image, i.e., a reference photograph of an identically constructed ring gear.

As shown in FIG. 7, at the start of alignment, the smartphone 16 is not in the correct position and orientation relative to the gear 2, since the live viewfinder image 22 of the camera 18, which shows the section of the gear 2 currently captured by the camera 18, is not congruent with the reference graphic 24.

An operator holding the smartphone 16 can now move the smartphone 16 closer to the gear 2 and rotate it relative to the gear 2 so that the live viewfinder image 22 shows a section of the gear 2 that is essentially congruent with the reference graphic 24. This aligned state is shown in FIG. 8.

The operator now triggers the camera 18 to produce a photographic image 26 of the contact pattern 8 in the aligned state according to FIG. 8.

The photographic documentation can be carried out by the operator using a software program product 28 that accesses the camera 18 and the display 20.

The software program product 28 is executed on the handheld electronic device 16 or is accessed web-based in a browser of the handheld electronic device 16.

The software program product 28 is configured to access a database 30 in which one or more of the following data are stored: Reference images 24 for different gear geometries; data for gear-specific designation of a photographic image and/or a reference image, such as a serial number, gear designation, gearing data, or the like; one or more document templates for generating reports 36 from the photographs 26 of contact patterns 8 and gear-specific reports generated from the document template or templates.

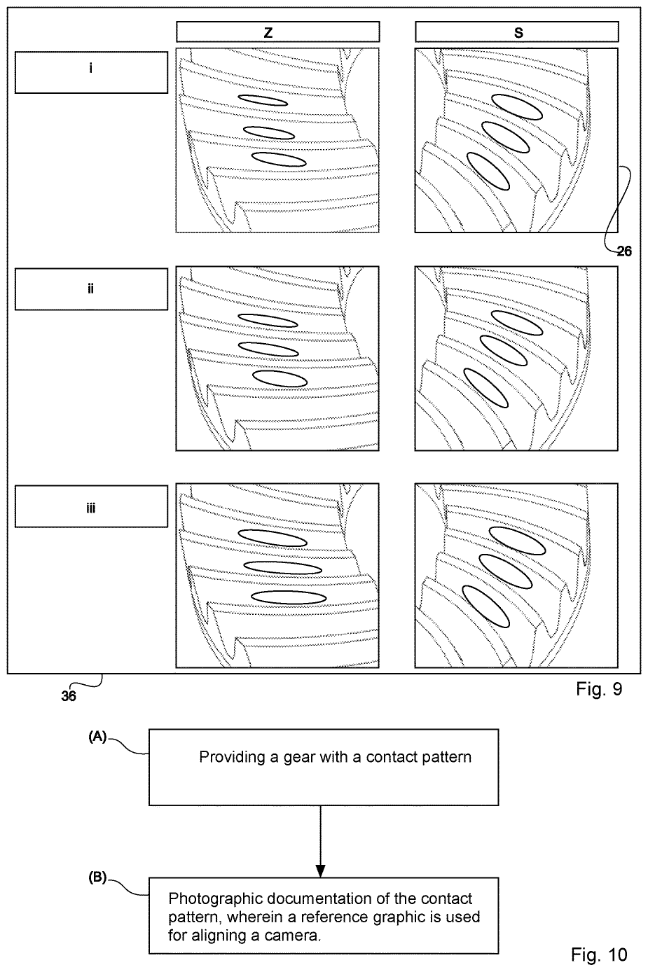

FIG. 9 shows an example of such a report 36, which records contact patterns of the tooth flanks of gear 2 in a first column Z and contact patterns images of the thrust flanks of gear 2 in a second column S after various finishing steps i, ii, iii.

In order to be able to immediately call up the correct reference image for a gear to be documented and to add gear-specific names from the database 30 to the protocol, a gear-specific, machine-readable QR code 32 can be scanned as part of the photographic documentation to identify the gearing 2.

The software program product 28 has a QR code scanner that accesses the camera 18 to capture the QR code 32.

By scanning the gear-specific, machine-readable QR code 32, gear-specific data is retrieved from the database 30. The gear-specific, machine-readable QR code 32 can be displayed on a monitor 34 of a gear cutting machine or a test bench.

During alignment and before triggering the camera 18, predefined parameters of the camera 18, such as exposure parameters and/or zoom settings or the like, can be called up, wherein these predefined parameters can be linked to the reference image 24 so that when the reference image 24 is called up, the predefined parameters for the camera 18 are also loaded.

The reference image 24 may have been generated prior to the photographic documentation of the gear 2. For this purpose, a reference image 34, i.e., a reference photograph of a ring gear 2′ identical in construction to the ring gear 2, may first have been created (FIG. 4).

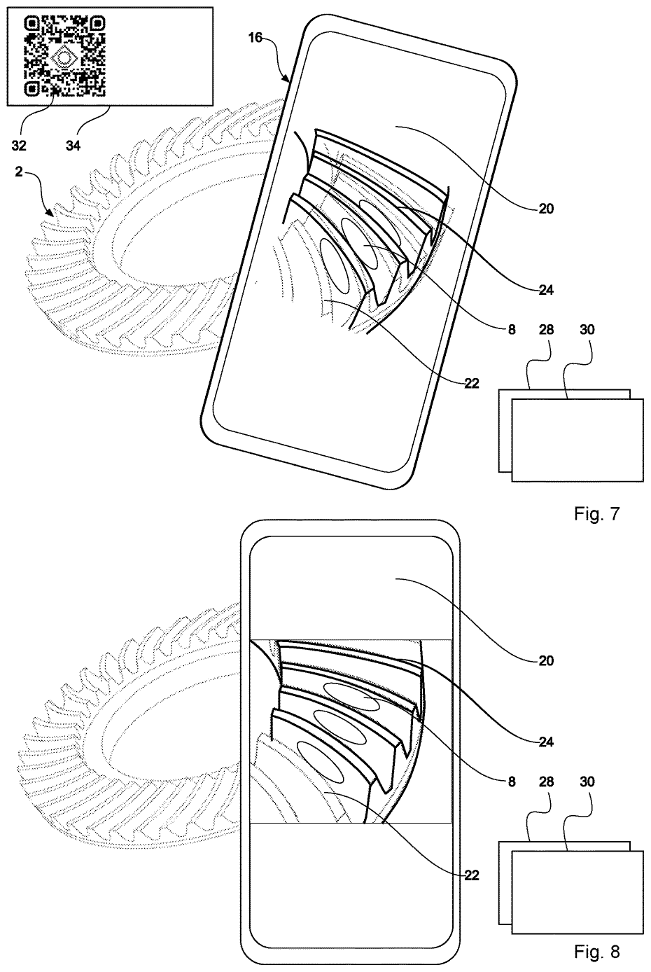

From this reference photograph 34, the reference graphic 24 in the form of contours has been derived by means of edge detection using the software program product 28 (FIG. 5, FIG. 6),

The smartphone 16 is therefore a device designed to photographically document the contact pattern 8 of the tooth flanks 4 of the gear 2.

The smartphone 16 is designed to superimpose a reference image 24 of at least a section of the gear 2 to be documented onto a live viewfinder image 22 of the camera 18 displayed on the display 20 during alignment and before the camera 18 is triggered, in order to enable repeatable, handheld alignment of the camera 18 relative to the gear 2 to be documented.

The method according to the disclosure therefore comprises the method steps (A) providing a gear with a contact pattern and (B) photographically documenting the contact pattern, using a reference graphic to align a camera,

1. A method including the following steps:
providing a gear,
wherein a substance for visualizing a contact pattern, is present on tooth flanks of the gear, and
wherein the substance has been partially removed and/or displaced as a result of the gear rolling against a counter gear, so that the contact pattern is visualized;
photographically documenting the contact pattern of one or more tooth flanks by
aligning a handheld electronic device, which has a camera and a display as an electronic viewfinder for the camera, relative to the contact pattern to be documented, wherein, during alignment and before triggering the camera, a reference image of at least a section of the gear is superimposed on a live viewfinder image of the camera displayed on the display in order to enable repeatable, handheld alignment of the camera relative to the gear, and
triggering the camera to produce a photographic image of the carrier image.

2. The method according to claim 1,
wherein
the reference image comprises a partially transparent reproduction of a photographic image of an identical gear
and/or
the reference image comprises at least one reference graphic derived from a photographic image of an identical gear,
and/or
the reference image comprises at least one reference graphic derived from target data of the gear.

3. The Method according to claim 1,
wherein the photographic documentation is carried out using a software program product that accesses the camera and the display, wherein the software program product is executed on the handheld electronic device or is accessed web-based in a browser of the handheld electronic device, wherein the software program product is designed to access a database in which one or more of the following data are stored:
reference images for different gear geometries;
data for gear-specific designation of a photographic image and/or a reference image, and
one or more document templates for generating reports from the photographic images of contact patterns and gear-specific reports generated from the document template or templates.

4. The method according to claim 3,
wherein,
as part of the photographic documentation, a gear-specific, machine-readable code, is scanned to identify the gearing, wherein the software program product has a code scanner, and wherein gear-specific data is retrieved from the database by scanning the gear-specific, machine-readable code, wherein the gear-specific, machine-readable code is displayed on a monitor of a gear cutting machine or a test bench.

5. The method according to claim 3,
wherein.
as a result of scanning the gear-specific, machine-readable code, a gear-specific reference image is retrieved from the database and/or added to a gear-specific protocol containing at least one photographic image of a contact pattern.

6. The method according to claim 1,
wherein
during alignment and before triggering the camera, predefined parameters of the camera, are called up, wherein the predefined parameters are linked to the reference image so that when the reference image is called up, the predefined parameters for the camera are also loaded.

7. The method according to claim 1,
wherein,
before photographically documenting a gear for which no reference image is yet available, one or more reference images are generated.

8. The method according to claim 1,
wherein the camera is triggered automatically if the reference image overlaps the gear to be documented with a predetermined degree of accuracy.

9. A device configured for photographic documentation of a contact pattern of one or more tooth flanks of a gear, wherein the device is a handheld electronic device, wherein the handheld electronic device has a camera and a display as an electronic viewfinder for the camera, wherein the device is designed to superimpose a reference image of at least a section of the gear to be documented on a live viewfinder image of the camera displayed on the display during alignment and before the camera is triggered, in order to enable repeatable, handheld alignment of the camera relative to the gear to be documented.

10. The device according to claim 9,
wherein the device is designed to perform the photographic documentation using a software program product that accesses the camera and the display, wherein the software program product is executed on the electronic device or is accessed web-based in a browser of the electronic device, wherein the software program product is designed to access a database in which one or more of the following data are stored:
reference images for different gear geometries;
data for naming a photographic image and/or a reference image;
one or more document templates for generating reports from the photographic images of contact patterns; and
gear-specific reports generated from the document template or document templates.
